(19) United States
(12) Patent Application Publication
(10) Pub. No.: US 2018/0247330 A1
(43) Pub. Date: Aug. 30, 2018

(54) LOCATION-BASED REWARD SYSTEM AND METHOD FOR AGGREGATED RETAILERS

(71) Applicant: Jeremy Duerr, Garden Ridge, TX (US)

(72) Inventor: Jeremy Duerr, Garden Ridge, TX (US)

(21) Appl. No.: 15/903,335

(22) Filed: Feb. 23, 2018

Related U.S. Application Data
(60) Provisional application No. 62/462,732, filed on Feb. 23, 2017.

(51) Int. Cl. G06Q 30/02; H04L 29/08; H04W 4/80; H04W 4/021

(52) U.S. Cl. CPC G06Q 30/0239; H04L 67/306; H04W 4/80; G06Q 30/0224; H04L 67/18; G06Q 30/0261; G06Q 30/0255; H04W 4/021

(57) ABSTRACT

A method is provided. A user profile is associated with a mobile device by a server. A proximity indicator is received by the server that indicates that the mobile device is in communication with a first beacon of a plurality of beacons positioned within a store associated with a retailer. Each beacon of the plurality of beacons is associated with a product offered for sale within the store, and the proximity indicator is triggered when the mobile device is with a predetermined distance from the first beacon. A retail profile is accessed by a server. The retailer profile includes GPS information for each beacon, traffic profiles for each beacon and advertising data for each beacon. Advertising data includes a coupon formula to calculate a coupon value that is proportional to reward points. The value of a coupon is calculated from reward point accumulated in the user profile using the coupon formula by the server, and a coupon is generated. The coupon is then transmitted to the mobile device from the server.

### CROSS-REFERENCE

This application claims priority to U.S. Patent Application Ser. No. 62/462,732, which was filed on Feb. 23, 2017, which is entitled “LOCATION-BASED REWARD SYSTEM AND METHOD FOR ADDREGARD RETAILERS,” and which is incorporated by reference herein for all purposes.

### TECHNICAL FIELD

The invention relates generally to direct advertising and, more particularly, to a location-based reward system for aggregated retailers.

### BACKGROUND

With the advent of the relatively inexpensive smartphone, tablets, and other mobile devices in the late 2000s, there has been a boon in on-line marketing. Retailers are now able to generate directed advertising for customers in real-time through wireless devices—such as smartphone and tablets—even to the point of doing it at near the point of sale. To do this, retailers have employed beacons that can be embedded in displays. These beacons are available through a wide variety of manufacturers, who can provide their own software development kits (SDKs) that enable retailers to create their own applications (or apps) for mobile devices. Some examples of some prior art systems are: U.S. Pat. No. 9,135,612; U.S. Pat. No. 9,460,433; U.S. Pre-Grant Publ. No. 2007/0282678; U.S. Pre-Grant Publ. No. 20110178862; U.S. Pre-Grant Publ. No. 2011/0178863; U.S. Pre-Grant Publ. No. 2015/0095129; and U.S. Pre-Grant Publ. No. 2016/0148238.

A problem with existing systems is that the market is fractured and does not generally allow for adequate competition between retailers. Today, each retailer offers its own app that is available for consumers to download and use for directed marketing. These types of systems can be very cumbersome in that multiple apps running simultaneously can consume computing resources, reduce battery life, and take storage space on mobile devices. Alternatively, apps—like shopkick (http://www.shopkick.com)—do provide directed marketing, but the marketing is not controlled by the retailers and does not allow the retailers to directly compete with one another.

Thus, there is a need for a method and/or system in which directed marketing or advertising can be aggregated among many retailers so as to allow more competition.

### SUMMARY

An embodiment of the disclosure, accordingly, provides a method. The method comprises: associating a user profile with a mobile device by a server, wherein the user profile is associated with login information entered in by the mobile device; selecting a first beacon type from a plurality of beacon types by the server based at least in part from the user profile; transmitting global positioning system (GPS) information of a beacon within a specified range from the server to the mobile devices over a wireless link, wherein the beacon is a first beacon type, and wherein the specified range is a stored setting on the server corresponding to the user profile, wherein the GPS information is configured to be displayed on a map on the mobile device; receiving a proximity indicator by the server that indicates that the mobile devices is in communication with the beacon, wherein the proximity indicator is triggered when the mobile device is with a predetermined distance from the beacon; determining targeted advertising data associated with the user profile and beacon by the server, wherein the targeted advertising data includes reward point accumulation and a promotion based at least in part on the user profile , and wherein the targeted advertising data is based at least in part on competitive data associated with the beacon; transmitting the targeted advertising from the server to the mobile device so as to notify the user of the targeted advertising data; updating the user profile by the server to reflect that a user has been within proximity to the beacon with timestamp of when the user was in proximity to the beacon; and updating a traffic profile associated with the first beacon type by the server, wherein the traffic profile includes the number proximity indications within a plurality of time intervals.

In accordance with an embodiment of this disclosure, the beacon further comprises a plurality of beacons.

In accordance with an embodiment of this disclosure, the server further comprises a plurality of servers.

In accordance with an embodiment of this disclosure, the plurality of time intervals is a first plurality of time intervals, and wherein the method further comprises: receiving a purchase indication associated with the beacon by the server; updating the user profile by the server to reflect that the user has purchased an item associated with the beacon; and updating the traffic profile associated with the first beacon type by the server, wherein the traffic profile includes the number of items associated with the beacon sold within a second plurality of time intervals.

In accordance with an embodiment of this disclosure, the promotion further comprises a coupon associated with the item, and wherein the value of the coupon is proportional to the reward point accumulation.

In accordance with an embodiment of this disclosure, the user profile includes an identifier, user interests, user purchase history, and shopping habits.

In accordance with an embodiment of this disclosure, each plurality of beacon types further comprises a unique beacon associated with a unique item.

In accordance with an embodiment of this disclosure, the beacon is a BLUETOOTH Low-Energy (BLE) beacon.

In accordance with an embodiment of this disclosure, a method is provided. The method comprises: associating a user profile with a mobile device by a server, wherein the user profile is associated with login information entered in by the mobile device; receiving a proximity indicator by the server that indicates that the mobile devices is in communication with a first beacon of a plurality of beacons positioned within a store associated with a retailer, and wherein each beacon of the plurality of beacons is associated with a product offered for sale within the store, and wherein the proximity indicator is triggered when the mobile device is within a predetermined distance from the first beacon; accessing a retail profile with the retailer by a server, wherein the retailer profile includes GPS information for each beacon, traffic profiles for each beacon and advertising data for each beacon, and wherein advertising data for each beacon includes a coupon formula to calculate a coupon value that is proportional reward points that is based at least in part on competitive data associated with each beacon; calculating the value of a coupon from reward point accumulated in the user profile using the coupon formula by the server; generating a coupon with the calculated coupon value by the server; and transmitting the coupon to the mobile device from the server.

In accordance with an embodiment of this disclosure, the method further comprises: receiving a purchase indication associated with the beacon by the server; updating the user profile by the server to reflect that a user associated with the user profile has purchased an item associated with the beacon; updating the traffic profile associated with the first beacon type by the server, wherein the traffic profile includes the number of items associated with the beacon sold within a second plurality of time intervals.

In accordance with an embodiment of this disclosure, the user profile includes an identifier, user interests, user purchase history, and shopping habits.

In accordance with an embodiment of this disclosure, a method is provided. The method comprises: associating a user profile with a mobile device by a server, wherein the user profile is associated with login information entered in by the mobile device, and wherein the user profile is associated with a user; receiving GPS location of the mobile device by the server; assembling a list of items that the user is likely to purchase based at least in part on a purchase history and a traffic history of user store in the user profile; accessing a plurality of retail profiles by the server, wherein each of the retail profiles is associated with a retailer from a plurality of retailers that is within a shopping radius of the GPS location of the mobile device, and wherein the shopping radius is stored in the user profile; comparing, by the server, the list of items that the user is likely to purchase to the items stored within the plurality of retail profiles accessed to generate a local items list, wherein each item on the local items list is associated a beacon having GPS location; transmitting the GPS location for each beacon associated with each item on the local items list to the mobile device, wherein the GPS location for each beacon associated with each item on the local items list to the mobile device is configured to be displayed on a map on the mobile device; receiving a proximity indicator by the server that indicates that the mobile devices is in communication with a first beacon that is associated with a first item on the local items list, wherein the proximity indicator is triggered when the mobile device is with a predetermined distance from the first beacon; determining, by the server, the number of accumulated reward points stored in the user profile; accessing, by the server, the retail profile associated with the retailer where the proximity indicator originated; retrieving a coupon formula from the retail profile accessed to calculate a coupon value that is proportional reward points by the server, wherein the coupon formula is based at least in part on a competitor's offering for a product associated with the first beacon; calculating the value of a coupon from the accumulated reward points in the user profile using the coupon formula by the server; generating a coupon with the calculated coupon value by the server; and transmitting the coupon to the mobile device from the server.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a is a block diagram illustrating an example of a system that employs directed marketing to consumers from aggregated retailers in accordance with an embodiment of the disclosure; and

FIGS. 2-5 are flow diagrams illustrating at least a portion of the operation of the system of FIG. 1.

### DETAILED DESCRIPTION

Refer now to the drawings wherein depicted elements are, for the sake of clarity, not necessarily shown to scale and wherein like or similar elements are designated by the same reference numeral through the several views.

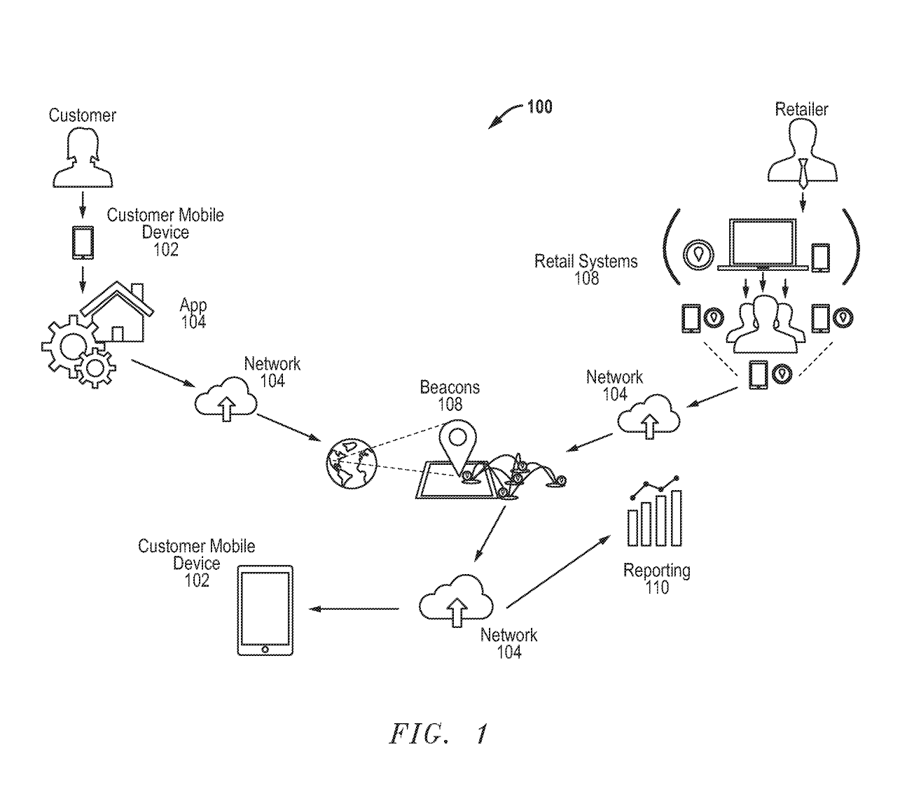

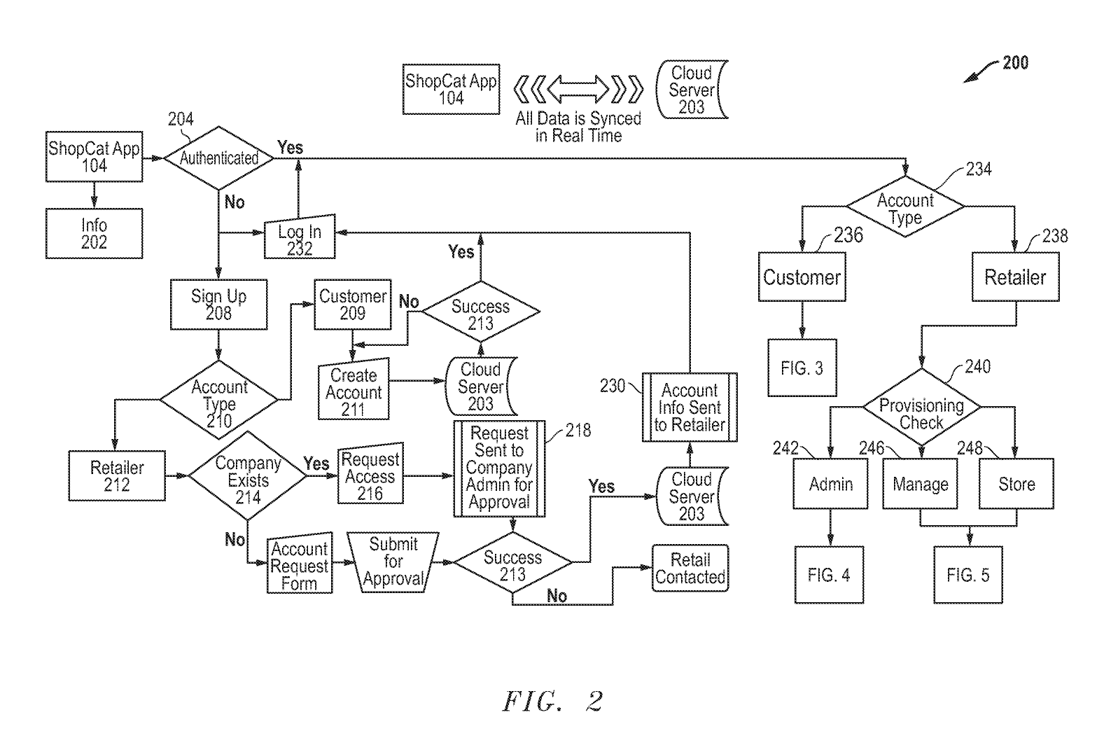

Referring to FIGS. 1 and 2 of the drawings, the reference numeral 100 generally designates a system in which aggregated retailers are able to provide directed marketing and/or advertising to consumers through mobile devices, while reference numeral 200 generally designates an example of the operation of the system 100. Typically, the app 104 is accessible through a mobile device 102 (e.g., tablet or smartphone), personal computer (PC), or laptop, or other computing or messaging device. In any case, the app 104 is able to communicate with server 203 that can host at least part of the system operations. The server 203 can be a variety of different types of servers, including, for example, internally hosted by the app supplier or as a cloud servers, and can be specific types of servers (e.g., a map server). Moreover, the server 203 may be comprised of one or more servers. The mobile device 102, PC, laptop, or other computing device generally accesses the server 203 through a switched packet network (e.g., the internet).

When a retailer or consumer accesses the app 104, the app 104 can authenticate the user—as shown in step 104 using information (e.g., username/password or biometric information) that associates can associate a user with a user profile. In the event that the authentication fails or a user (be it retailer or consumer) desires to create a new profile, the user can sign up for the appropriate account type in steps 208 and 210. A registration process for a consumer is typically simple, but, because of the sensitivity of the information that can be contained with the server 203, the registration process for retailers is typically more involved.

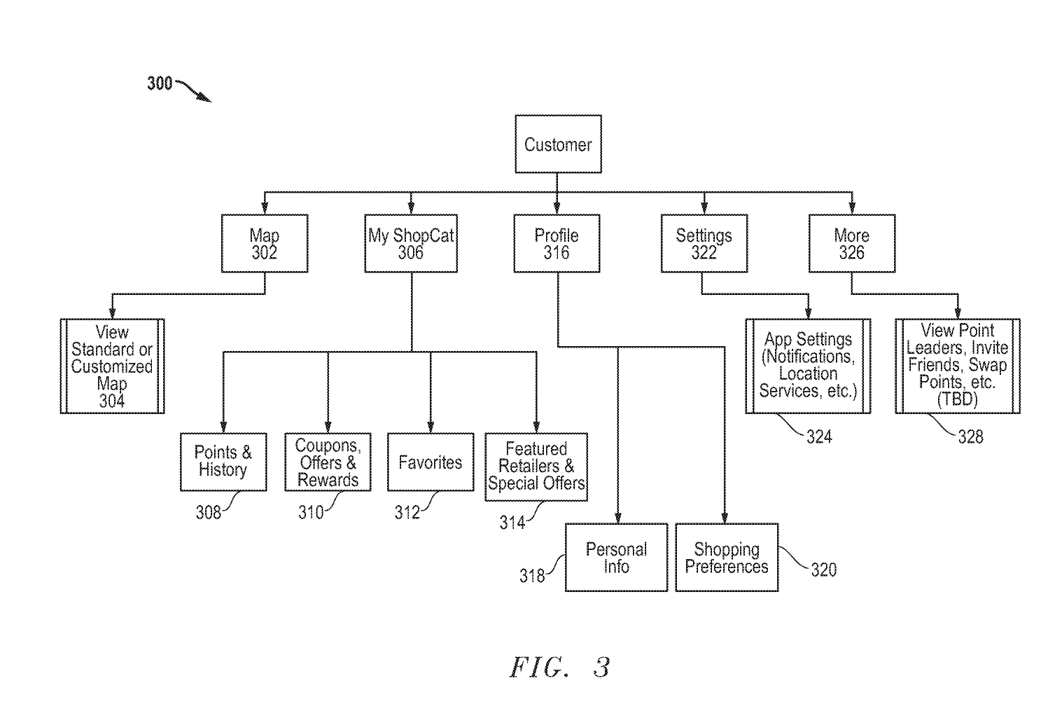

Beginning with a consumer registration, a consumer may enter pertinent information in a fillable form provided through the app 104. Typically, the entry of the information relating to a consumer is accomplished through steps 209, 211, and 213. The type of information that a consumer can enter is at least partially shown in FIG. 3—where reference numerals generally depict the flow for a consumer or user profile. When a consumer fills out an on-line form or submits data in another manner (e.g., from a third party database like those offered at FACEBOOK®), the app 104 may allow the consumer to enter some personal information 318 (e.g., user name/password, age, gender, interest, and so forth) and shopping preferences 320 (e.g., favorite stores, favorite types of items shop for, and so forth). The app 104 may also allow the user to create the appropriate view for a map in 304 through the map settings 302; for example, the app 104 can allow the user to adjust a map view if location service for the mobile device 102 (e.g., use of global positioning system (GPS) location) are enabled and enter a shopping radius from specific location or from the location of the mobile device 102 (e.g., GPS location). The user may also be able to access directed advertising or marketing information through the marketing menu 306. This directed marketing or advertising information can be reward points accumulated for purchases from retailers and shopping history in 308, coupons and rewards offered from retailers in 310, favorite items to purchase in 302, and/or featured retailers/special offers in 314. The user may also adjust the security and activity setting for the app 324 through the settings 322. Security settings can enable the user to activate or deactivate location settings of the mobile device 102 (e.g., GPS location) and control the level of personal information provided to retailers. Activity settings can allow the consumer to tailor the types of notifications or directed marketing/advertising that he/she would like to receive; for example, a consumer may select the setting such that he/she will only receive coupons having a value that is proportional to reward point accumulated (e.g, in 310). Additionally, a consumer (through more 326) may also be able to perform other tasks or see other data (such as consumers among a group with the largest number of accumulated reward points, inviting friends to groups, swapping points for specific retailers, and so forth). Coupons, promotions, discounts or any other kinds of offers from the retailers can be independent of accumulated reward points. Even cash rewards may be offered based on reward point accumulation.

Typically as part of registration and account maintenance, retailers may add, remove, or replace locations of stores on a map along with an associated point value, and designate promotions, coupons, discounts, and/or rewards customers will receive upon visiting these locations. When a customer visits a store, the associated retailer would usually incur a fee. This is generally accomplished through the mobile device 102 relaying data (e.g., location data) to server 203. For example, if Store A is worth 12 points and points cost $0.10 each, the retailer can be charged $1.20 per unique store visitor per day. This allows the retailers control Customer Acquisition Cost (CAC) and advertising expense. This can be one of the most effective marketing tactics because retailers will know the customer received their advertising (unlike traditional TV, radio, print, and broad-based broadcasting approaches), and the retailers can receive additional info from the customer such as name, email, gender, age and shopping preferences. With multiple retailers competing, this can also create a more competitive advertising marketplace in that retailers can make differing reward point offerings. For example, if Retailer A can see Retailer B's is offering 15 points per visit, Retailer A may decide to increase its point award to 16 per visit to attract customers. Thus, way the system look can naturally set the market rate for reward points offered that can be used for real-time promotions, discounts, and rewards. Typically, as part of the retail accounts, alerts can be provided to managers, or persons with oversight privilege, when a competitor has adjusted a reward level or the account can be set to automatically modify rewards or promotions (e.g., coupon values) in response to competitors. For example, competitive data may indicate that Retailer B change an offer of 14 points for a specific products associated with a becon to 15 points; in response to the change, the system 100 may automatically adjust Retailer A's offering to 16 points for the same products (which can also be associated with a beacon). Limits on automatic changes for may also be included as part of retail accounts.

Retail registration, on the other hand, generally requires additional organizational approval. For an organization that already has an administrative retail account in the system 100, the process shown in reference numerals 214, 216, 224, 226, and 230 generally provides the registration flow. Typically, the organization with the administrative account is contacted for approval in 218; this is generally accomplished through mail, email, or phone to help ensure data integrity. Otherwise, if the organization does not have an administrative account, an administrative account can be created through the completion of an account request form in 220. The account request form in 220 can be an on-line, fillable similar to the one a consumer can create in 211. Like the situation where an additional account (e.g., for a manager) can be created for an organization having an administrative account, it, too, is generally submitted for approval in 222 (e.g., by phone, mail, or email). With approval, the accounts can be created on the server 203 in 230; otherwise, the retailer can be contacted of a possible breach or attempted breach in 226.

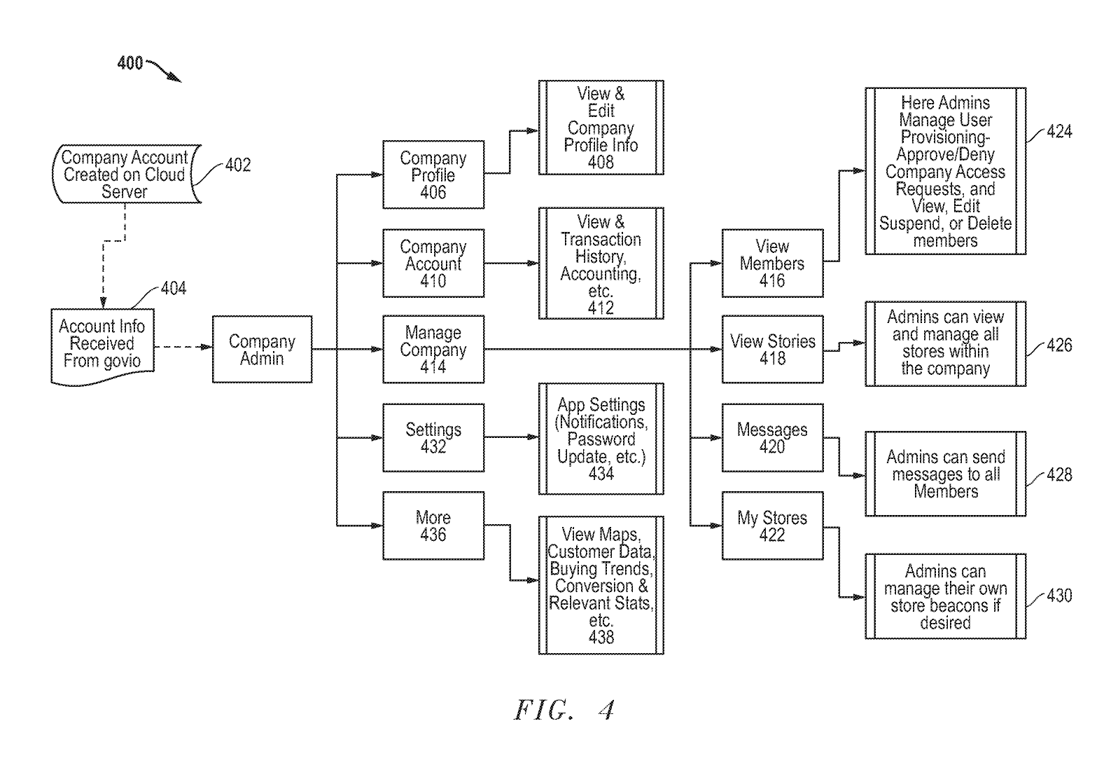

Usually, when a retailer sets up an administrative account (initially or otherwise), there is a certain amount of information that is generally required. The type of data that an administrator, or someone with access to an organization's administrative privileges, can enter or have access to is shown in FIG. 4—where reference numeral 400 generally designates the flow for an administrative account. As shown, after creation, the account can be accessed in 402 with data retrieval in 404. Usually, data about the company (e.g., name, mailing address, billing address, contact persons, contact phone numbers) can be viewed, entered, and edited in 406 and 408. This information can typically be edited through an on-line form. The person with administrative access can also view account history and transaction history through 410 and 412; typically, the person without administrative access is not able to edit the account history and transaction history. The person with administrative access may also maintain password and notification control through 423 and 434. Generally, the functionality of the administrative account overlaps with that of a store account or manager account (each of which generally requires approval from administration of the organization for creation), but the administrative account typically exerts managerial control over the stores and managers. This is typically done in one of two ways: the manage company flow 414 and the more flow 436. Additionally, it should be noted that other venues, like stadiums, can use such beacons 108 to attract patrons to sales.

Turning first to manage company flow 414, the person with administrative access can exert managerial control. One of the principal functions of an administrator or person with administrative access, generally, is to control the access/account list which can be done in 416 and 424—where the specific manager and store accounts can be added, deleted, and suspended. Alternatively, the list can be partitioned according to store in 418 and 426. The administrator may also send messages through the system to persons within their list (e.g., like a closed network or intranet email) in 420 and 428; an example is described below with respect to message 514. The beacons 108 for each store can also be managed in 422 and 430, but this is covered in more detail below with respect to manager and store accounts.

Now, turning to the more flow 436, this is—generally speaking—Reporting 110. Reporting 110 can be characterized as determining trends for customer and stores. For example, the system 100 can report basic traffic patterns through stores (e.g., paths taken by customers) based on the reporting beacon proximity detections by mobile devices 102. This data for traffic patterns can be correlated to demographic (e.g., age and gender) and time of day (e.g., where the day is broken up into intervals) and items purchased to determine better or optimal locations for displays with beacons and to determine better or optical coupon and promotion incentives that will entice customers to purchase items. The traffic patterns may even be correlated to the store layout so that the system 100 can predictively determine better or optimal store layouts based on substantially maximize sales. Additionally, a user (who has the ability in the app 104) may be able to report the sale of items so as to accumulate reward points; this can be accomplished through a number of ways, but the most convenient is typically to identify the purchase with an identifier (e.g., alphanumeric string). Moreover, the system 100 may be able to report competitor pricing, coupon, and promotion information that can allow a retailer to price match or offer competitive coupons and promotions.

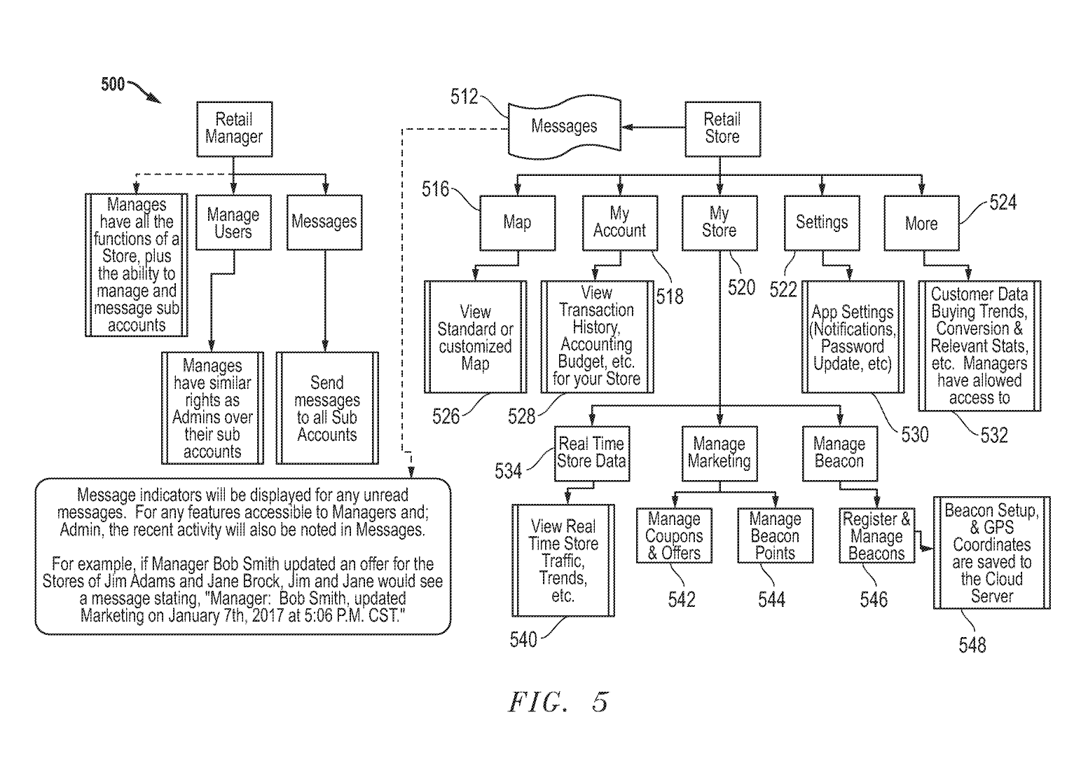

As described above, store and manager accounts are typically more limited in functionality compared to administrative accounts. Turning to FIG. 5, reference numeral 500 generally designates the flows for manager and store accounts. Typically, the manager accounts have all of the functionality of the store accounts but include additional functionality in that users within the store (who have access to the store account) can be managed in 504 and 506 in that the manager can add, delete, suspend, and maintain general administrative control and individually send messages in 508 and 510. The store account can include multiple accounts with varying levels of access. For example, a user having access to a store account may only be able edit beacon 208 locations. Typically, these store accounts are able to send messages through 512 (an example message is shown in 514). The map view of the store including its location on a broader map is generally customizable by all store users in 516 and 526. Account information in 518 and 528 (which can include transaction history for the store, budgeting, and accounting information) and reporting 110 for the store (through 524 and 532) are typically limited to accounting and managerial staff of the store (unless otherwise provisioned by admins or managers). Additionally, the passwords and notifications settings can be edited by each store user.

Generally, based on the responsibilities of the user, the controls under by My Store flow 520 would vary. For managerial and marketing staff, real-time data (including reporting 110) can be viewed through 534 and 540, and marketing management of reward points for visits, coupons, and other promotional offers can be managed through 536, 542, and 544. Generally, for all store users, the beacons 108 can be registered by location in 538, 546, and 548. For example, when a stocker moves a display, the new location for the display (including the GPS location) can be registered through a wireless device carried by the stocker. The beacons 108 can also be a wide varity of beacons (such as WiFi, BLE, and virtual beacons). Additionally, retailers can set the sensitivity of their location. For example, a retailer could choose to reward points for entering a specific GPS range or may require the user to be in proximity of the actual beacon location.

With registration by users (which can include both customers and retailers), operation is generally accomplished through the login flows in 234, 236, 238, 242, 246, and 248. One of the simplest descriptions of the operation of the system 100 is from the customer's prospective. When a user logs in through an app 105 on his/her mobile device 102 over network 104, the server 203 can associate the user login credentials to a user profile (e.g., data stored via flow 300). Based, for example, on the traffic history (e.g., stores frequented at the time of day accessed), preference, purchase history, interests, and wish lists, the server 203 can compile a list of potential items for purchase. The server 203 can then transmit the locations for beacon 108 within a specified shopping location for all retailers that have bacons registered on the system 100. The location can be the GPS location of the mobile device 102 or some other location specified by the user (e.g., the entire continental United States). The data is generally formatted such that it can be displayed on a map on the mobile device 102. For example, if the user logs in at noon, the server 203 may discern that the only purchases made at noon are for foods and that the foods purchased tend to be meat, cheese, bread, and potato chips. So, the server 203 can compile a list of foods within those categories. The app 104 can then display a map showing all of the beacons 108 associated with those items within a radius of 5 miles of the GPS location of the mobile device 102.

Once within the venue, the system 100 can monitor the real-time traffic and sales information for users. This is generally accomplished by having the mobile device 102 transmit a proximity detection of a beacon 108 to the server 203 over network 104. Usually, there is an identifier (e.g., alphanumeric string) associated with each beacon 108 that is transmitted to the server. For example, when a mobile device is within 3 feet of a BLE beacon, the BLE beacon transmits its identifier to a mobile device 102. Thus, as the user (and his/her mobile device) move through a store or venue, the path of the person can be estimated. Moreover, the server 203 can send the user through the mobile device 102 promotions or coupons for items associate with beacon proximity detections. The sever 203 can, for example, calculate a coupon for an item based on reward points. For example, if the user passes a display of a certain brand of bread—triggering a proximity detection, the server 203 determines this user has purchase this brand of bread in the past at the same time, and determines that the user has 106 reward points for the retailer, the server 203 can transmit a coupon for $1.06 off of the bread or offer the same coupon for a competing brand. Similarly, standard coupons and promotions can be sent to the mobile device 102 in real-time.

One advantage of the system 100 is that it is able to generate traffic patterns for all retailers that have venues or stores registered. The traffic patterns can include the paths each mobile device took through the stores, the items purchased, the demographics, and time of day in which the movements and transactions took place. These patterns and the known layout for the store and venue can automatically determine which doors are used more often, which aisles are traversed more often, which items are more frequently purchased, and the dominant demographics. The system can then generate a suggested store layout that places frequently sold items within the most traveled paths, to place items which the store is promoting within the most traveled paths, or to change the layouts to make the more traveled paths longer to allow users to spend more time viewing products while in transit. The may also be able to suggest specific types of displays (e.g., color) based on the demographics for these frequented paths. Additionally, it is possible for consumers to receive bonus points for proximity (e.g., proximity to a beacon or a GPS location) even when the app 104 is not currently operating on the mobile device 102.

Another advantage of the system 100 is that a user would not necessarily have to download multiple apps (e.g., one for each retailer). All registered retailers could use the same system 100 and be able to compete for customers and adjust advertising and promotions before the users ever enter a store or other venue.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. A method comprising:
associating a user profile with a mobile device by a server, wherein the user profile is associated with login information entered in by the mobile device;
selecting a first beacon type from a plurality of beacon types by the server based at least in part from the user profile;
transmitting global positioning system (GPS) information of a beacon within a specified range from the server to the mobile devices over a wireless link, wherein the beacon is a first beacon type, and wherein the specified range is a stored setting on the server corresponding to the user profile, wherein the GPS information is configured to be displayed on a map on the mobile device;
receiving a proximity indicator by the server that indicates that the mobile devices is in communication with the beacon, wherein the proximity indicator is triggered when the mobile device is with a predetermined distance from the beacon;
determining targeted advertising data associated with the user profile and beacon by the server, wherein the targeted advertising data includes reward point accumulation and a promotion based at least in part on the user profile, and wherein the targeted advertising data is based at least in part on competitive data associated with the beacon;
transmitting the targeted advertising from the server to the mobile device so as to notify the user of the targeted advertising data;
updating the user profile by the server to reflect that a user has been within proximity to the beacon with timestamp of when the user was in proximity to the beacon; and
updating a traffic profile associated with the first beacon type by the server, wherein the traffic profile includes the number proximity indications within a plurality of time intervals.

2. The method of claim 1, wherein the beacon further comprises a plurality of beacons.

3. The method of claim 1, wherein the server further comprises a plurality of servers.

4. The method of claim 1, wherein the plurality of time intervals is a first plurality of time intervals, and wherein the method further comprises:
receiving a purchase indication associated with the beacon by the server;
updating the user profile by the server to reflect that the user has purchased an item associated with the beacon; and
updating the traffic profile associated with the first beacon type by the server, wherein the traffic profile includes the number of items associated with the beacon sold within a second plurality of time intervals.

5. The method of claim 4, wherein the promotion further comprises a coupon associated with the item, and wherein the value of the coupon is proportional to the reward point accumulation.

6. The method of claim 5, wherein the user profile includes an identifier, user interests, user purchase history, and shopping habits.

7. The method of claim 6, wherein each plurality of beacon types further comprises a unique beacon associated with a unique item.

8. The method of claim 7, wherein the beacon is a BLUETOOTH Low-Energy (BLE) beacon.

9. A method comprising:
associating a user profile with a mobile device by a server, wherein the user profile is associated with login information entered in by the mobile device;
receiving a proximity indicator by the server that indicates that the mobile devices is in communication with a first beacon of a plurality of beacons positioned within a store associated with a retailer, and wherein each beacon of the plurality of beacons is associated with a product offered for sale within the store, and wherein the proximity indicator is triggered when the mobile device is within a predetermined distance from the first beacon;
accessing a retail profile with the retailer by a server, wherein the retailer profile includes GPS information for each beacon, traffic profiles for each beacon and advertising data for each beacon, and wherein advertising data for each beacon includes a coupon formula to calculate a coupon value that is proportional reward points that is based at least in part on competitive data associated with each beacon;
calculating the value of a coupon from reward point accumulated in the user profile using the coupon formula by the server;
generating a coupon with the calculated coupon value by the server; and
transmitting the coupon to the mobile device from the server.

10. The method of claim 9, wherein the server further comprises a plurality of servers.

11. The method of claim 9, wherein the method further comprises:
receiving a purchase indication associated with the beacon by the server;
updating the user profile by the server to reflect that a user associated with the user profile has purchased an item associated with the beacon;
updating the traffic profile associated with the first beacon type by the server, wherein the traffic profile includes the number of items associated with the beacon sold within a second plurality of time intervals.

12. The method of claim 11, wherein the user profile includes an identifier, user interests, user purchase history, and shopping habits.

13. The method of claim 12, wherein the beacon is a BLE beacon.

14. A method comprising:
associating a user profile with a mobile device by a server, wherein the user profile is associated with login information entered in by the mobile device, and wherein the user profile is associated with a user;
receiving GPS location of the mobile device by the server;
assembling a list of items that the user is likely to purchase based at least in part on a purchase history and a traffic history of user store in the user profile;
accessing a plurality of retail profiles by the server, wherein each of the retail profiles is associated with a retailer from a plurality of retailers that is within a shopping radius of the GPS location of the mobile device, and wherein the shopping radius is stored in the user profile;
comparing, by the server, the list of items that the user is likely to purchase to the items stored within the plurality of retail profiles accessed to generate a local items list, wherein each item on the local items list is associated a beacon having GPS location;
transmitting the GPS location for each beacon associated with each item on the local items list to the mobile device, wherein the GPS location for each beacon associated with each item on the local items list to the mobile device is configured to be displayed on a map on the mobile device;
receiving a proximity indicator by the server that indicates that the mobile devices is in communication with a first beacon that is associated with a first item on the local items list, wherein the proximity indicator is triggered when the mobile device is with a predetermined distance from the first beacon;
determining, by the server, the number of accumulated reward points stored in the user profile;
accessing, by the server, the retail profile associated with the retailer where the proximity indicator originated;
retrieving a coupon formula from the retail profile accessed to calculate a coupon value that is proportional reward points by the server, wherein the coupon formula is based at least in part on a competitor's offering for a product associated with the first beacon;
calculating the value of a coupon from the accumulated reward points in the user profile using the coupon formula by the server;
generating a coupon with the calculated coupon value by the server; and
transmitting the coupon to the mobile device from the server.

15. The method of claim 14, wherein the method further comprises:
updating the user profile by the server to reflect that a user has been within proximity to the first beacon with a timestamp of when the user was in proximity to the first beacon; and
updating a traffic profile for the first item by the server, wherein the traffic profile includes the number proximity indications within a plurality of time intervals.

16. The method of claim 15, wherein the plurality of time interval is a first plurality of time intervals, and wherein the method further comprises:
receiving a purchase indication associated with the beacon by the server;
updating the user profile by the server to reflect that the user has purchased the first item;
updating the traffic profile associated with the first item by the server, wherein the traffic profile includes the number of first items sold within a second plurality of time intervals.

17. The method of claim 16, wherein the user profile includes an identifier, user interests, user purchase history, and shopping habits.

18. The method of claim 17, wherein the server further comprises a plurality of servers.

19. The method of claim 18, wherein the beacon is a BLE beacon.
